(19) United States
(12) Patent Application Publication
(10) Pub. No.: US 2017/0242545 A1
(43) Pub. Date: Aug. 24, 2017

(54) TOUCH PANEL DEVICE

(71) Applicant: Sharp Kabushiki Kaisha, Sakai City, Osaka (JP)

(72) Inventors: Tomohiro KIMURA, Sakai City (JP); Yasuhiro SUGITA, Sakai City (JP)

(21) Appl. No.: 15/504,336

(22) PCT Filed: Aug. 17, 2015
(86) PCT No.: PCT/JP2015/073045

§ 371 Date: Feb. 16, 2017

(30) Foreign Application Priority Data
Aug. 22, 2014 (JP) 2014-169108

(51) Int. Cl. G06F 3/041; G06F 3/044

(52) U.S. Cl. CPC G06F 3/0418; G06F 3/044; G06F 2203/04112

(57) ABSTRACT

Provided is a touch panel device having improved operability, with reduced electric power consumption in a touch panel thereof. A touch panel device (100) includes a case (B1), a touch panel (TP), a switch (SW), and a controller. The switch (SW) provided on a side surface of the case (B1) is a switch for activating the touch panel (TP), the switch being provided in an area within such a distance from the touch panel that the switch (SW) can be capacitively coupled with the touch panel (TP). The controller controls the touch panel (TP) and the switch (SW).

### TECHNICAL FIELD

The present invention relates to a technique used in a touch panel device, a display device on which a touch panel is mounted, an information terminal device, and the like.

### BACKGROUND ART

A touch panel device is a device to which information can be input by a finger touch or a pen touch with respect to a touch panel surface of the device. In recent years, a capacitive type touch panel device having good detection sensitivity and excellent operability is used in a variety of equipment. Particularly, a projected capacitive type touch panel device that is capable of highly accurately detecting coordinates of a point on a touch panel surface thereof in contact with a finger or a pen is used in many cases (for example, see Patent Document 1 (U.S. Pat. No. 6,452,514)).

One exemplary application of a device in which such a touch panel device is used is a touch-panel-equipped display device.

### SUMMARY OF THE INVENTION

### Problem to be Solved by the Invention

In a conventional touch-panel-equipped display device, in order to reduce the electric power consumption, a switch for activating a touch panel thereof is provided on, for example, a case thereof, so that the touch panel is activated with use of this switch, only when the touch panel is used. In other words, in such a touch-panel-equipped display device, it is necessary to cause the touch panel to shift to an active state with a switch when the touch panel is to be operated, and the operation thereof is complicated as compared with, for example, a touch-panel-equipped display device in which a touch panel is kept in an active state at all times. In other words, in the case of this touch-panel-equipped display device, in order to operate a touch panel thereof, the following two steps (a two-stage operation) have to be carried out: (1) a step of making the touch panel active with use of a switch; and (2) a step of touching the touch panel so as to perform an operation with use of the touch panel. In the case of this touch-panel-equipped display device, the above-described two steps (the two-stage operation) have to be carried out, and hence, the operation is complicated as compared with a touch-panel-equipped display device in which a touch panel thereof is kept in an active state at all times.

In light of the above-described problem, it is an object of the present invention to provide a touch panel device having improved operability, with reduced electric power consumption in a touch panel thereof.

### Means to Solve the Problem

In order to solve the above-described problem, the first configuration is a touch panel device that includes a capacitive type touch panel, a first switch, and a controller.

The first switch is a switch for activating the touch panel, the switch being provided in an area within such a distance from the touch panel that the switch can be capacitively coupled with the touch panel.

The controller controls the touch panel and the first switch.

### Effect of the Invention

The present invention makes it possible to realize a touch panel device having improved operability, with reduced electric power consumption in a touch panel thereof.

### BRIEF DESCRIPTION OF DRAWINGS

FIG. 1 illustrates a schematic exploded perspective view of a touch-panel-equipped display device 100 according to Embodiment 1 (left diagram) and a perspective view of the touch-panel-equipped display device 100 (right diagram).

FIG. 2 illustrates a plan view of the touch-panel-equipped display device 100 according to Embodiment 1 (upper diagram), and a schematic cross-sectional view of the same taken along line A-A (lower diagram).

FIG. 3 illustrates a plan view of the touch-panel-equipped display device 100 according to Embodiment 1 (upper diagram), and a schematic cross-sectional view of the same taken along line A-A (lower diagram).

FIG. 4 is an expanded view illustrating the terminal part 1 and part of a sense electrode layer L_S of a touch panel TP in the plan view of the touch-panel-equipped display device 100 according to Embodiment 1 (upper diagram), and further illustrating sense lines SL1 to SL8.

FIG. 5 illustrates a logic configuration of the touch-panel-equipped display device 100 according to Embodiment 1.

FIG. 6 illustrates (1) a mesh pattern R1(L_D) formed with thin metal wires of a drive electrode layer L_D, and (2) a mesh pattern R1(L_S) formed with thin metal wires of the sense electrode layer L_S, at a point R1 in FIGS. 3 and 4, which are displayed superimposed.

FIG. 7 is a view for explaining a display interlocking operation (display rotation, display sliding) in the touch-panel-equipped display device 100 according to Embodiment 1.

FIG. 8 is a view for explaining a display interlocking operation (display scale-down, display scale-up) in the touch-panel-equipped display device 100 according to Embodiment 1.

FIG. 9 is a schematic plan view illustrating a touch-panel-equipped display device 100A according to Modification Example 1 of Embodiment 1, viewed from above a display surface.

FIG. 10 is a schematic plan view illustrating a touch-panel-equipped display device 100B including a switch SW1 and a switch SW2, viewed from above a display surface.

FIG. 11 is a schematic plan view illustrating a touch-panel-equipped display device 100C according to Modification Example 2 of Embodiment 1, viewed from above a display surface.

FIG. 12 is a schematic plan view illustrating the touch-panel-equipped display device 100C according to Modification Example 2 of Embodiment 1, viewed from above the display surface.

FIG. 13 illustrates a schematic exploded perspective view of a conventional touch-panel-equipped display device 900 (left diagram), and a perspective view of the touch-panel-equipped display device 900 (right diagram).

FIG. 14 illustrates a plan view of the conventional touch-panel-equipped display device 900 (upper diagram) and a schematic cross-sectional view of the same taken along line A-A (lower diagram).

FIG. 15 illustrates a plan view of the conventional touch-panel-equipped display device 900 (upper diagram) and a schematic cross-sectional view of the same taken along line A-A (lower diagram).

FIG. 16 illustrates a logic configuration of the conventional touch-panel-equipped display device 900.

### MODE FOR CARRYING OUT THE INVENTION

### Embodiment 1

The following description describes Embodiment 1 while referring to the drawings.

Hereinafter, as an exemplary device in which a touch panel device is used, a touch-panel-equipped display device is described.

First, in order to facilitate comparison, a conventional touch-panel-equipped display device is described.

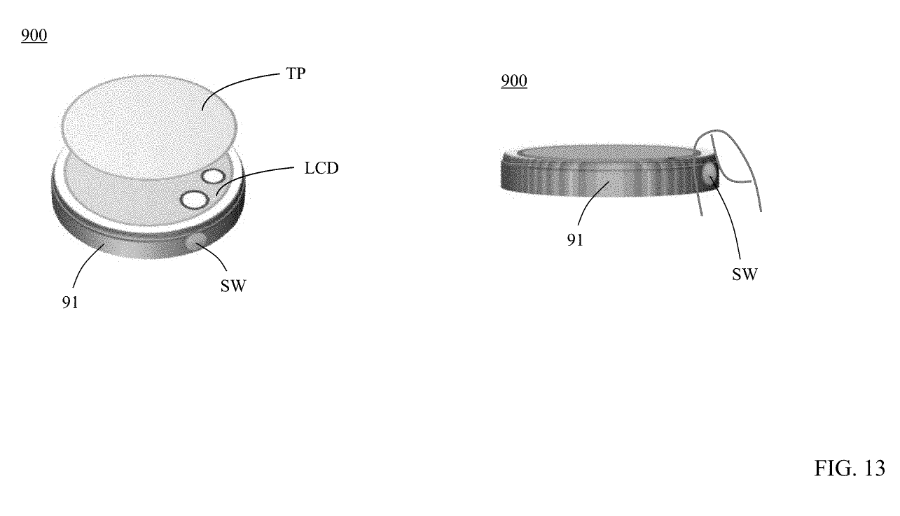

In FIGS. 13 to 16, views for explaining a touch-panel-equipped display device 900 are shown.

More specifically, FIG. 13 illustrates a schematic exploded perspective view of the touch-panel-equipped display device 900 (left diagram), and a perspective view of the touch-panel-equipped display device 900 (right diagram).

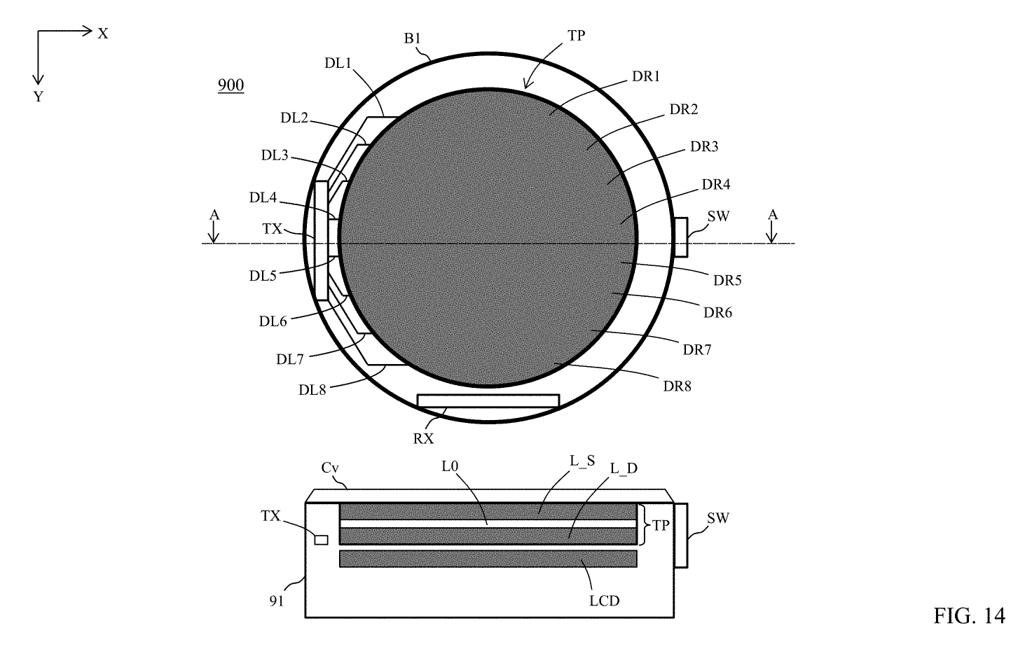

FIG. 14 illustrates a plan view of the touch-panel-equipped display device 900 (upper diagram), and a schematic cross-sectional view of the same taken along line A-A (lower diagram). The upper diagram in FIG. 14 illustrates a drive electrode layer L_D, a transmitter (drive electrode actuation unit) TX, and drive lines DL1 to DL8 of the touch panel TP.

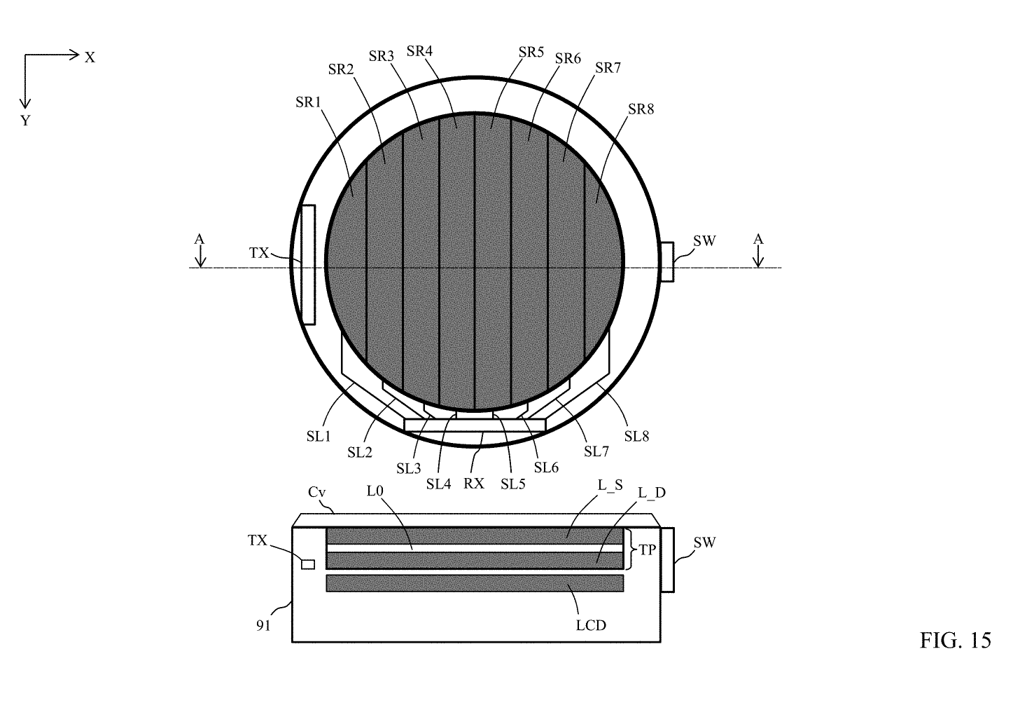

FIG. 15 illustrates a plan view of the touch-panel-equipped display device 900 (upper diagram), and a schematic cross-sectional view of the same taken along line A-A (lower diagram). The upper diagram in FIG. 15 illustrates a sense electrode layer L_S of a touch panel TP thereof, a receiver (sense electrode receiver) RX, and sense lines SL1 to SL8.

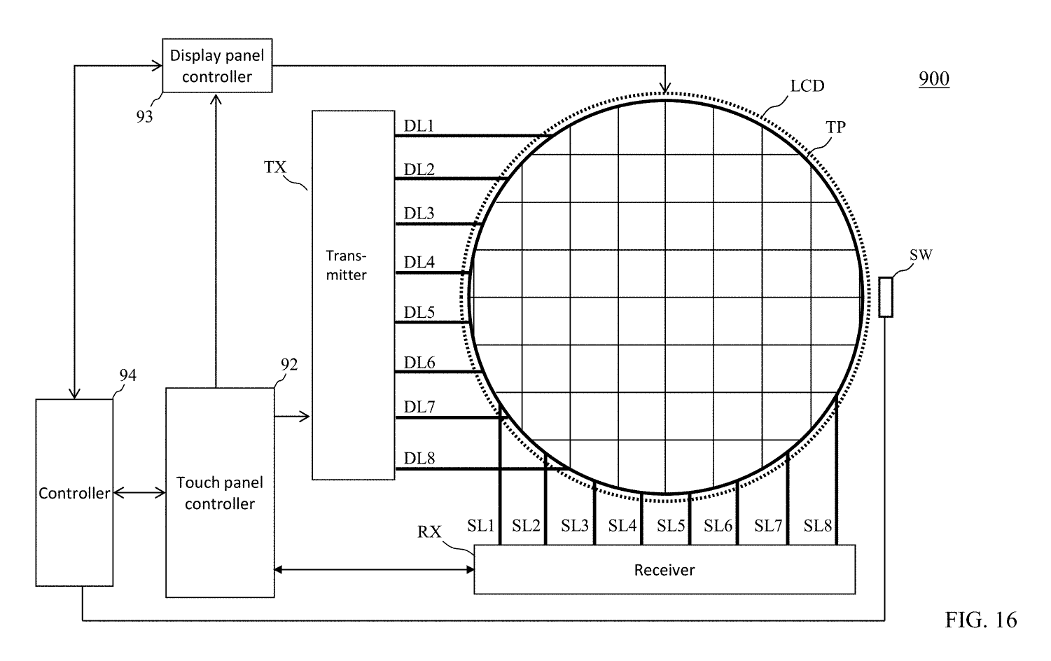

FIG. 16 illustrates a logic configuration of the touch-panel-equipped display device 900.

As illustrated in FIG. 13, the touch-panel-equipped display device 900 includes a case 91, a display panel (for example, liquid crystal display) LCD, and a touch panel TP. Further, The touch-panel-equipped display device 900 includes a switch SW for driving the touch panel TP, on a side surface of the case 91. Still further, as illustrated in FIG. 16, the touch-panel-equipped display device 900 includes a touch panel controller 92, a display panel controller 93, a controller 94, a transmitter TX, drive lines DL1 to DL8, a receiver RX, and sense lines SL1 to SL8.

As illustrated in FIGS. 14 and 15, the touch panel TP includes a drive electrode layer L_D, a sense electrode layer L_S, and an insulating layer L0.

In the drive electrode layer L_D, drive electrodes are formed with, for example, a mesh pattern made of thin metal wires. By forming the drive electrode layer L_D with a mesh pattern made of the thin metal wires having a smaller line width, the light from the display panel LCD can be prevented from being blocked.

As illustrated in FIG. 14, the drive electrode layer L_D is composed of the eight drive electrode areas DR1 to DR8. The eight drive electrode areas DR1 to DR8 are connected to the transmitter TX by the drive lines DL1 to DL8, respectively. The drive electrode areas DR1 to DR8 are driven in response to drive signals output from the transmitter TX through the drive lines DL1 to DL8, and in the drive electrode areas DR1 to DR8, electric fields according to the drive signals are generated, respectively.

As illustrated in FIGS. 14 and 15, the insulating layer L0 is provided between the drive electrode layer L_D and the sense electrode layer L_S, whereby the drive electrode layer L_D and the sense electrode layer L_S are insulated from each other by the insulating layer L0.

As illustrated in FIG. 15, the sense electrode layer L_S is composed of the eight sense electrode areas SR1 to SR8. The eight sense electrode areas SR1 to SR8 are connected to the receiver RX by the sense lines SL1 to SL8, respectively.

The receiver RX receives sense signals through the sense lines SL1 to SL8, the sense signals corresponding to changes in the electric fields that are generated due to the drive signals between the sense electrode areas SR1 to SR8 and the drive electrode areas DR1 to DR8.

As illustrated in FIG. 16, the touch panel controller 92 is connected to the transmitter TX, the receiver RX, the display panel controller 93, and the controller 94. The touch panel controller 92 outputs a control signal for the drive actuation of the transmitter TX (drive control signal). The transmitter TX, based on the control signal (drive control signal) from the touch panel controller 92, outputs a predetermined drive signal through the drive lines DL1 to DL8 to the drive electrode areas DR1 to DR8 on the touch panel TP at predetermined timings. Further, the touch panel controller 92, based on the reception signals received by the receiver RX through the sense lines SL1 to SL8, detects position information of a touch point on the touch panel TP. Then, the touch panel controller 92 outputs the position information of the detected touch point to the display panel controller 93 and the controller 94.

The display panel controller 93 is a controller for controlling the driving of the display panel LCD, and as illustrated in FIG. 16, the display panel controller 93 is connected to the touch panel controller 92 and the controller 94. The display panel controller 93 controls the display of the display panel LCD based on the control signals from the controller 94 and/or the touch panel controller 92.

The controller 94 is a functional unit that performs overall control of the touch-panel-equipped display device 900, and as illustrated in FIG. 16, the controller 94 is connected to the touch panel controller 92, the display panel controller 93, and the switch SW. When the switch SW is touched by a user (or when the switch SW is pressed down) (when an operation for shifting the switch SW to a switch ON state is executed), the controller 94 outputs, to the touch panel controller 92, a control signal that instructs the touch panel TP to shift to an active state (operable state), so that the touch panel TP shifts to an active state. The touch panel controller 92 starts the controlling the driving of the touch panel TP based on the control signal from the controller 94, thereby causing the touch panel TP to shift to an active state (operable state).

With such a processing operation being executed, in the touch-panel-equipped display device 900, a finger touch by a user with respect to the switch SW causes the touch panel TP of the touch-panel-equipped display device 900 to shift to an active state, whereby a touch panel operation can be performed by a finger touch or the like by a user with respect to a touch panel surface.

In this way, in the case of the touch-panel-equipped display device 900, a user, using the switch SW, causes the touch panel TP to shift to an active state when he/she performs an operation on the touch panel TP, which reduces the electric power consumption for driving the touch panel TP. In other words, in the touch-panel-equipped display device 900, only when the touch panel TP is operated, the touch panel TP shifts to an active state (a state in which the touch panel TP is driven), and this makes it possible to reduce the electric power consumption, as compared with a case where the touch panel TP is kept in an active state at all times.

In the case of such a touch-panel-equipped display device 900 as described above, however, it is necessary to causes the touch panel TP to shift to an active state by using the switch SW when the touch panel TP is operated, and hence, the operation is complicated as compared with a case of a touch-panel-equipped display device in which the touch panel TP is kept in an active state at all times. In other words, in the case of the touch-panel-equipped display device 900, it is necessary to perform the following two steps (two-stage operation) in order to operate the touch panel TP: (1) a step of causing the touch panel TP to shift to an active state, by using the switch SW; and (2) a step of touching the touch panel TP so as to perform an operation with use of the touch panel TP. In the case of the touch-panel-equipped display device 900, since the above-described two steps (the two-stage operation) have to be carried out, the operation is complicated, as compared with the case of the touch-panel-equipped display device in which the touch panel TP is kept in an active state at all times.

Next, the following description describes a touch-panel-equipped display device 100 according to Embodiment 1.

### <1.1: Configuration of Touch-Panel-Equipped Display Device>

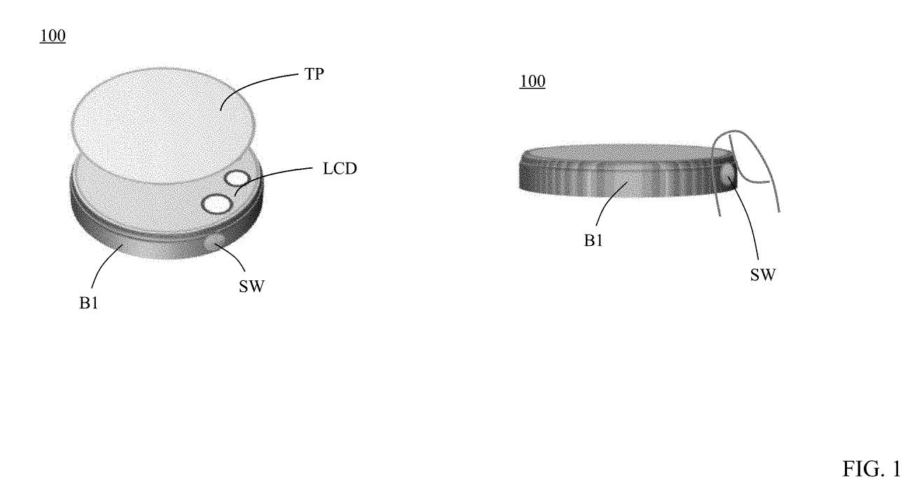

FIG. 1 illustrates a schematic exploded perspective view of the touch-panel-equipped display device 100 (left diagram), and a perspective view of the touch-panel-equipped display device 100 (right diagram).

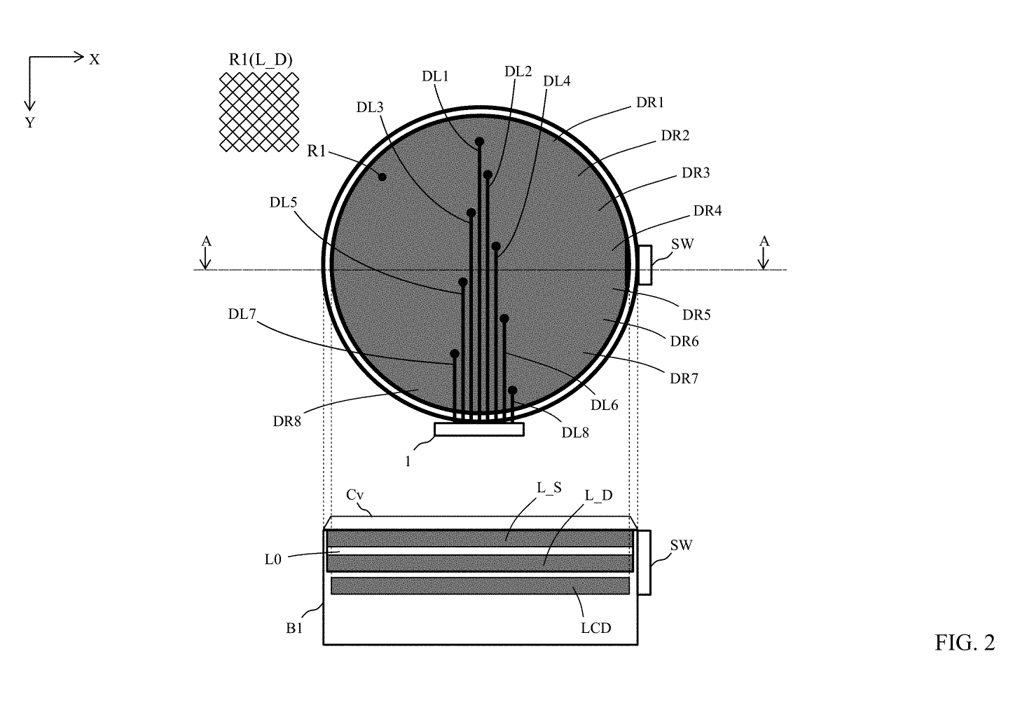

FIG. 2 is a plan view of the touch-panel-equipped display device 100 (upper diagram) and a schematic cross-sectional view of the same taken along line A-A (lower diagram). The upper diagram in FIG. 2 illustrates a drive electrode layer L_D of a touch panel TP, a terminal part 1, and drive lines DL1 to DL8.

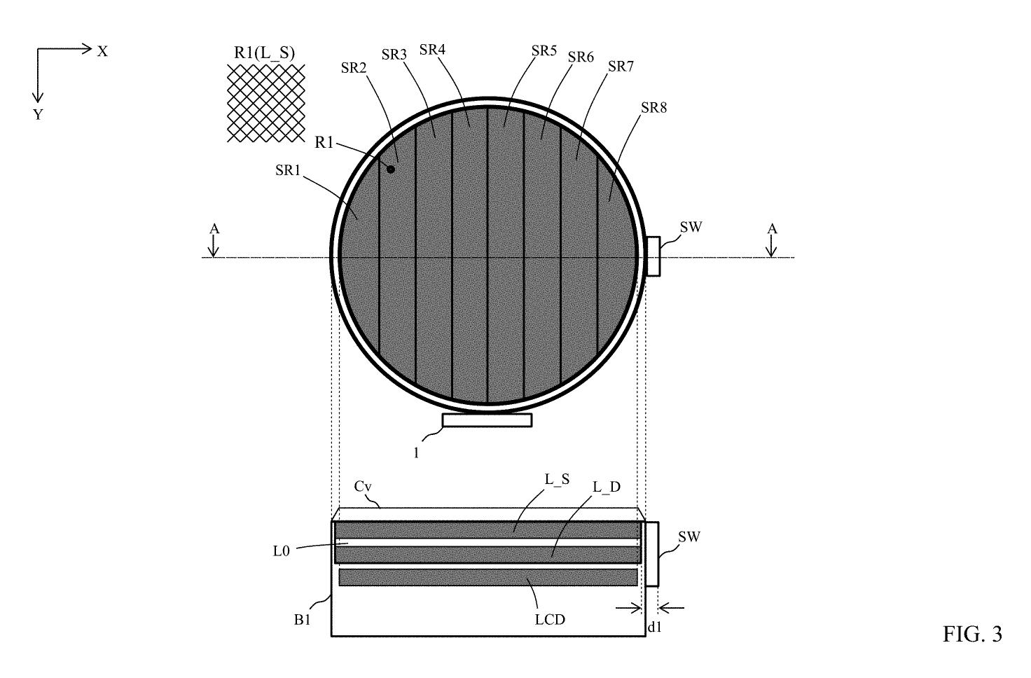

FIG. 3 illustrates a plan view of the touch-panel-equipped display device 100 (upper diagram), and a schematic cross-sectional view of the same taken along line A-A (lower diagram). The upper diagram in FIG. 3 illustrates a sense electrode layer L_S of the touch panel TP, and the terminal part 1.

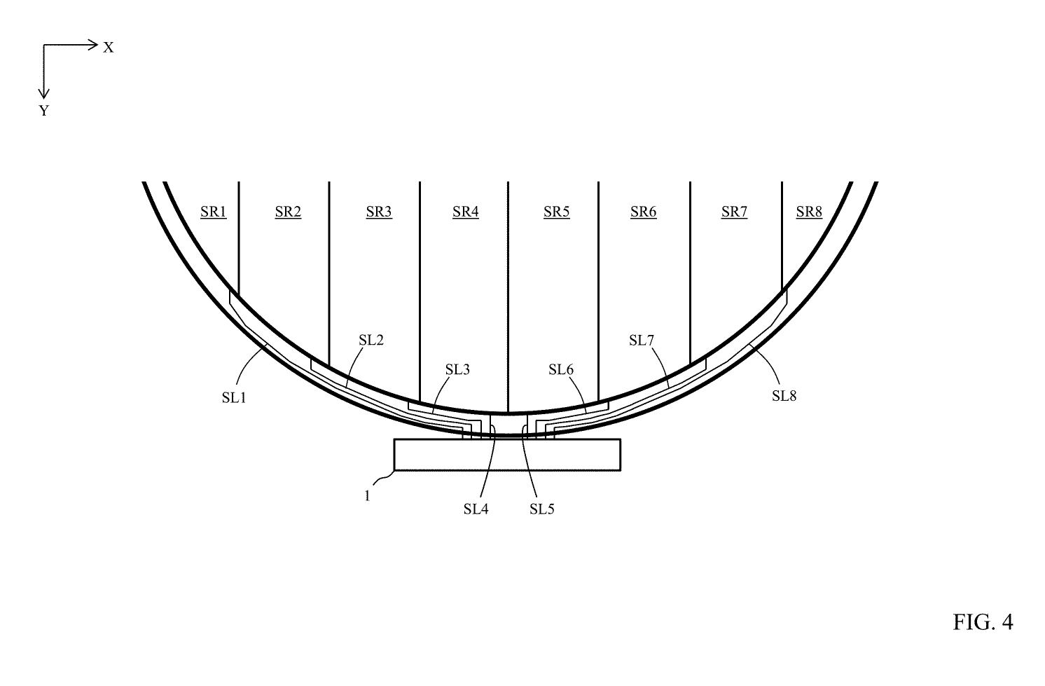

FIG. 4 is an expanded view illustrating the terminal part 1 and part of the sense electrode layer L_S of the touch panel TP, and further illustrating sense lines SL1 to SL8, in the plan view of the touch-panel-equipped display device 100 illustrated in FIG. 3 (upper diagram).

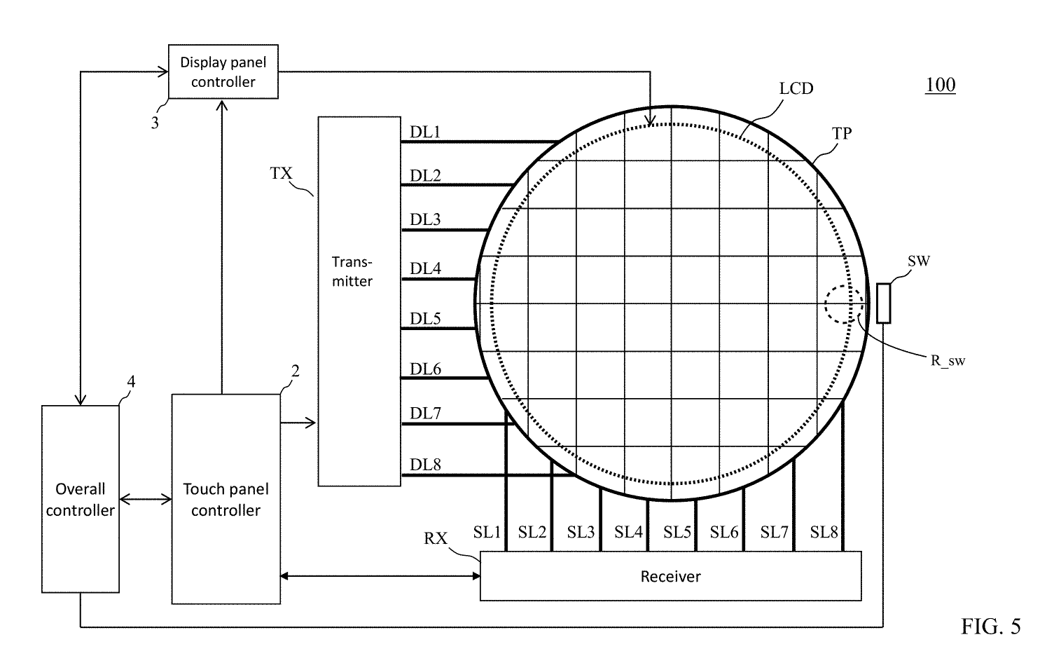

FIG. 5 illustrates a logic configuration of the touch-panel-equipped display device 100.

The touch-panel-equipped display device 100, as illustrated in FIG. 1, includes a case B1, a display panel (for example, a liquid crystal display, an organic EL display, or the like) LCD, and a touch panel TP. Further, the touch-panel-equipped display device 100 includes a switch SW for driving the touch panel TP on a side surface of the case B1. Further, the touch-panel-equipped display device 100, as illustrated in FIG. 5, includes a touch panel controller 2, a display panel controller 3, an overall controller 4, a transmitter TX, drive lines DL1 to DL8, a receiver RX, and sense lines SL1 to SL8.

As illustrated in FIGS. 1 to 3, the case B1 is a case for housing a touch panel TP and a display panel LCD. Further, the case B1 is a case for housing the terminal part 1, the transmitter TX, the receiver RX, the touch panel controller 2, the display panel controller 3, and the overall controller 4, illustrated in FIGS. 1 to 5. By attaching a cover Cv formed with a transparent member over the case B1 as illustrated in FIGS. 2 and 3, the touch panel TP, the display panel LCD, and the like arranged in the case B1 can be protected from dust and the like.

The display panel LCD is a display panel such as a liquid crystal display, an organic EL display, or the like. The display panel LCD is arranged on a lower side of the touch panel TP (case side) as illustrated in FIG. 1, and displays a predetermined image (video image) on the display surface based on control signals from the overall controller 4 and the display panel controller 3.

The touch panel TP is, for example, a projected capacitive type touch panel. The touch panel TP is arranged on an upper side of the display panel LCD (cover Cv side) as illustrated in FIG. 1. The touch panel TP is configured so that the driving of the drive electrodes is controlled by the touch panel controller 2 and the transmitter TX. According to reception signals received by the sense electrodes and the receiver RX (signals corresponding to changes in the electric fields on the touch panel TP (capacitance changes)), a touch position on the touch panel TP is detected.

The touch panel TP, as illustrated in FIGS. 2 and 3, includes a drive electrode layer L_D, a sense electrode layer L_S, and an insulating layer L0 for insulating the drive electrode layer L_D and the sense electrode layer L_S from each other.

The drive electrode layer L_D has, for example, such a configuration that drive electrodes are formed with a mesh pattern composed of thin metal wires. By forming the drive electrode layer L_D with a mesh pattern formed with thinner metal wires, light from the display panel LCD can be prevented from being blocked. For example, at a point R1 in FIG. 2, the drive electrode layer L_D is formed with a mesh pattern composed of thin metal wires, which is denoted by “R1(L_D)” in FIG. 2. In areas other than the point R1 in the drive electrode layer L_D, similarly, drive electrodes are formed with a mesh pattern composed of thin metal wires.

The drive electrode layer L_D is composed of eight drive electrode areas DR1 to DR8 as illustrated in FIG. 2. The eight drive electrode areas DR1 to DR8 are connected to the drive lines DL1 to DL8, respectively. Ends on one side of the drive lines DL1 to DL8 are connected to connection terminals (not shown) of the terminal part 1. In other words, the drive lines DL1 to DL8 are connected to the transmitter TX through the corresponding connection terminals of the terminal part 1, respectively. In FIGS. 2 to 4, for convenience of explanation, the terminal part 1 is illustrated as being arranged outside a peripheral region (frame region) of the touch panel TP, but actually it is preferable that the terminal part 1 is housed in the inside of the case B1.

The drive lines DL1 to DL8 are, as illustrated in FIG. 2, formed within the touch panel area of the touch panel TP, when viewed in a plan view. For example, the drive lines DL1 to DL8 are arranged in areas where the sense electrodes of the sense electrode layer L_S are not formed. The drive lines DL1 to DL8 are connected to the drive electrode areas DR1 to DR8, respectively, via through holes provided in the insulating layer L0 (through holes at, for example, positions indicated by solid circles in FIG. 2 when viewed in a plan view).

The drive electrode areas DR1 to DR8 are driven by drive signals output from the transmitter TX through the drive lines DL1 to DL8, respectively, and in the drive electrode areas DR1 to DR8, electric fields corresponding to the drive signals are generated, respectively.

In the sense electrode layer L_S, sense electrodes are formed by, for example, a mesh pattern composed of thin metal wires. By forming the sense electrode layer L_S with a mesh pattern composed of thinner metal wires, light from the display panel LCD can be prevented from being blocked. For example, at a point R1 in FIG. 3 (a point R1 that is present at a coordinate position identical to that of the point R1 in FIG. 4 when viewed in a plan view), the sense electrode layer L_S is formed with a mesh pattern composed of thin metal wires, which is denoted by “R1(L_S)” in FIG. 3. In areas other than the point R1 in the sense electrode layer L_S, similarly, drive electrodes are formed with a mesh pattern composed of thin metal wires.

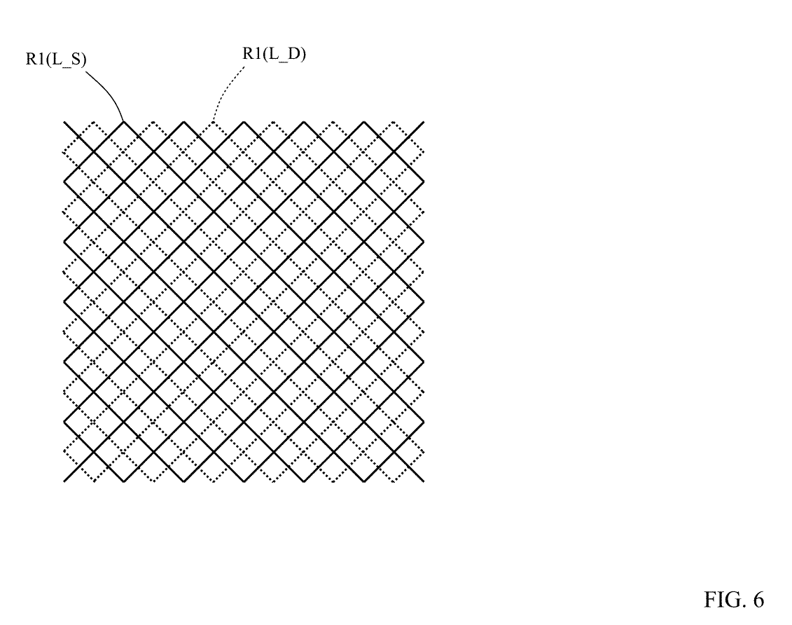

FIG. 6 illustrates (1) the mesh pattern R1(L_D) formed with thin metal wires of the drive electrode layer L_D, and (2) the mesh pattern R1(L_S) formed with thin metal wires of the sense electrode layer L_S, at the point R1 in FIGS. 3 and 4, which are displayed superimposed.

As illustrated in FIG. 6, preferably, the mesh pattern R1(L_D) composed of the thin metal wires of the drive electrode layer L_D, and the mesh pattern R1(L_S) composed of the thin metal wires of the sense electrode layer L_S are mesh patterns in which the wires are arranged at identical pitches, and the mesh patterns are arranged at such positions that they are deviated by half pitch from each other when viewed in a plan view. With such an arrangement, cross capacitances generated between the drive electrodes and the sense electrodes can be reduced.

The sense electrode layer L_S is composed of eight sense electrode areas SR1 to SR8, as illustrated in FIGS. 3 and 4. As illustrated in FIG. 4, the eight sense electrode areas SR1 to SR8 are connected to the sense lines SL1 to SL8, respectively. Ends on one side of the sense lines SL1 to SL8 are connected to connection terminals (not shown) of the terminal part 1. In other words, the sense lines SL1 to SL8 are connected to the receiver RX through the corresponding connection terminals of the terminal part 1, respectively.

The sense lines SL1 to SL8 are, as illustrated in FIG. 4, formed within a peripheral region (frame region) of the touch panel TP, when viewed in a plan view. In the touch-panel-equipped display device 100, as described above, since the drive lines DL1 to DL8 are formed within the touch panel area of the touch panel TP, only the sense lines SL1 to SL8 may be arranged in the peripheral region (frame region) of the touch panel TP. In the touch-panel-equipped display device 100, therefore, it is not necessary to arrange both of the drive lines DL1 to DL8 and the sense line SL1 to SL8 in the peripheral region (frame region) of the touch panel TP, unlike the conventional touch-panel-equipped display device 900 illustrated in FIGS. 14 and 15. As a result, in the touch-panel-equipped display device 100, the peripheral region (frame region) of the touch panel TP can be formed significantly smaller, as compared with the conventional touch-panel-equipped display device.

The transmitter TX is connected to the drive electrode areas DR1 to DR8 by the drive lines DL1 to DL8, respectively. The transmitter TX inputs control signals (drive control signals) from the touch panel controller 2. The transmitter TX outputs drive signals for driving the drive electrode areas DR1 to DR8 at predetermined timings, based on the control signals (drive control signals) from the touch panel controller 2, through the drive lines DL1 to DL8, respectively.

The receiver RX is connected to the sense electrode areas SR1 to SR8 by the sense lines SL1 to SL8, respectively. The receiver RX inputs control signals from the touch panel controller 2. The receiver RX receives sense signals through the sense lines SL1 to SL8 based on the control signals from the touch panel controller 2. More specifically, the receiver RX receives sense signals corresponding to changes in the electric fields (capacitance changes) that are generated between the sense electrode areas SR1 to SR8 and the drive electrode areas DR1 to DR8 due to the drive signals, through the sense lines SL1 to SL8.

The touch panel controller 2 is connected to the transmitter TX, the receiver RX, the display panel controller 3, and the overall controller 4, as illustrated in FIG. 5. The touch panel controller 2 outputs a control signal for the drive actuation (drive control signal), to the transmitter TX. The transmitter TX outputs a predetermined drive signal based on the control signals (drive control signals) from the touch panel controller 2, through the drive lines DL1 to DL8, to the drive electrode areas DR1 to DR8 of the touch panel TP, at predetermined timings. Further, the touch panel controller 2 detects position information of the touch point on the touch panel TP based on the reception signals that the receiver RX receives through the sense lines SL1 to SL8. Then, the touch panel controller 2 outputs the position information of the detected touch point to the display panel controller 3 and the overall controller 4.

The display panel controller 3 is a controller for controlling the driving of the display panel LCD, and as illustrated in FIG. 5, the display panel controller 3 is connected to the touch panel controller 2 and the overall controller 4. The display panel controller 3 controls of the display of the display panel LCD based on the control signals from the overall controller 4 and/or the touch panel controller 2.

The overall controller 4 is a functional unit that performs overall control of the touch-panel-equipped display device 100, and as illustrated in FIG. 5, the overall controller 4 is connected to the touch panel controller 2, the display panel controller 3, and the switch SW. When the switch SW is touched by a user (or when the switch SW is pressed down) (when an operation for shifting the switch SW to a switch ON state is executed), the overall controller 4 outputs, to the touch panel controller 2, a control signal that instructs the touch panel TP to shift to an active state (operable state), so that the touch panel TP shifts to an active state. The touch panel controller 2 starts controlling the driving of the touch panel TP based on the control signal from the overall controller 4, thereby causing the touch panel TP to shift to an active state (operable state).

The switch SW is provided on a side surface of the case B1 as illustrated in FIGS. 1 to 3. The switch SW is arranged in such a manner that the distance between the surface of the switch SW that a user touches and the switch SW-side end of the touch panel TP is equal to or smaller than the distance that allows capacitive coupling between these. For example, in FIG. 3, the switch SW is arranged on a side surface of the case B1 in such a manner that the distance dl (distance dl illustrated in FIG. 3) between the surface of the switch SW that a user touches and a switch SW-side end of the touch panel TP is equal to or smaller than the distance that allows capacitive coupling therebetween. The distance dl is, for example, 3 mm or less. The distance dl is preferably 2 mm or less. In addition, for example, it is preferable that the capacitance in a region from the touch panel TP to the switch SW is ½ or greater than the capacitance in a region between the electrode surface of the touch panel TP and the surface (input surface of the touch-panel-equipped display device 100).

The switch SW is, for example, realized by a switch formed with a mechanical button (for example, a mechanical button that shifts to an ON state when pressed down), or a switch formed with a touch sensor (for example, an electrostatic sensor). As illustrated in FIG. 5, the switch SW is connected to the overall controller 4, and shifts to a switch ON state when, for example, the switch SW is touched (or pressed down) by a user. The shift of the switch SW to a switch ON state when the switch SW is touched (or pressed down) by a user causes, for example, electric current to flow through a circuit formed together with the overall controller 4, and by detecting this electric current, the overall controller 4 detects the switch ON state.

### <1.2: Action of Touch-Panel-Equipped Display Device>

The following description describes actions of the touch-panel-equipped display device 100 that is configured as described above.

Here, the initial state of the touch-panel-equipped display device 100 is assumed to be a state in which an image is displayed on the display panel LCD, and the touch panel TP is in a non-active state.

In order to perform an operation with the touch panel TP (in order to cause the touch panel TP to shift to an active state), a user touches the switch SW with a finger, so that the switch SW shifts to a switch ON state.

The overall controller 4 detects that the switch SW is touched by the user with the finger, and outputs a control signal for driving the touch panel TP to the touch panel controller 2.

The touch panel controller 2 receives the control signal from the overall controller 4, and starts controlling the driving of the touch panel TP based on the control signal. More specifically, the touch panel controller 2 outputs a touch panel actuation control signal to the transmitter TX.

The transmitter TX generates a drive signal for sequentially performing output to the drive lines DL1 to DL8, based on the touch panel actuation control signal received from the touch panel controller 2. The transmitter TX outputs the generated drive signals through the drive lines DL1 to DL8 to the drive electrode areas DR1 to DR8, respectively. With the drive signals thus output, electric fields corresponding to the drive signals are generated between the drive electrode areas DR1 to DR8 and the sense electrode areas SR1 to SR8, respectively.

The receiver RX sequentially receives the sense signals from the sense lines SL1 to SL8, based on the control signal from the touch panel controller 2. The touch panel controller 2 identifies a position on the touch panel TP at which an electric field change (capacitance change) occurs, based on the signals received by the receiver RX through the sense lines SL1 to SL8.

In a case where a user touches the switch SW with a finger, an electric field change (capacitance change) in the area R_sw illustrated in FIG. 5 becomes noticeable. In this case, the following signals indicate significant electric field changes (capacitance changes): (1) a sense reception signal that the receiver RX receives through the sense line SL8 when the drive line DL4 is driven by the transmitter TX; and (2) a sense reception signal that the receiver RX receives through the sense line SL8 when the drive line DL5 is driven by the transmitter TX.

The touch panel controller 2 detects a signal change of the sense signal, and determines that the position information (coordinate position) of the touch position indicates somewhere around an area R_sw in FIG. 5. In other words, the area R_sw in the vicinities of the finger touching the switch SW is detected as a touch position.

The touch-panel-equipped display device 100 has such a configuration that the touch panel TP has a small peripheral region (frame region), and the distance between the touch surface of the switch SW and the end of the touch panel TP (switch SW-side end) is so small as to allow the capacitive coupling therebetween, so that the position of a touch on the touch surface of the switch SW can be detected by the touch panel TP. In the touch-panel-equipped display device 100, therefore, when a user executes an operation for activating the touch panel TP using the switch SW (operation of causing the touch panel TP to shift to an active state), approximately at the same time as this operation, the position information of the finger of the user touching the switch SW (the area R_sw in FIG. 5) can be detected.

As a result of this, in the case of the touch-panel-equipped display device 100, unlike a conventional touch-panel-equipped display device, it is not necessary to perform the following two steps (two-stage operation): (1) a step of causing the touch panel TP to shift to an active state, by using the switch SW; and (2) a step of touching the touch panel TP so as to perform an operation with use of the touch panel TP. In other words, in the case of the touch-panel-equipped display device 100, without such a complicated operation as that of a conventional touch-panel-equipped display device, upon the activation of the touch panel TP, substantially simultaneously (with substantially no delay), the position of a user's finger touching the switch SW can be detected with use of the touch panel TP. With this configuration, the touch-panel-equipped display device 100 has operability that is significantly improved as compared with conventional cases.

Further, in the case of the touch-panel-equipped display device 100, when the touch panel is operated, the touch panel TP is activated by the switch SW. The electric power, therefore, is consumed in the touch panel TP only when the touch panel is operated. This makes it possible to reduce the electric power consumption for the touch panel operation, while improving the operability of the touch panel operation.

It should be noted that the functions of the “controller” are realized by, for example, the touch panel controller 2 and the overall controller 4.

### (1.2.1: Display Interlocking Operation (Display Rotation, Display Sliding))

Next, the following description describes a case where, in the touch-panel-equipped display device 100, a display interlocking operation (display rotation, display sliding) is performed.

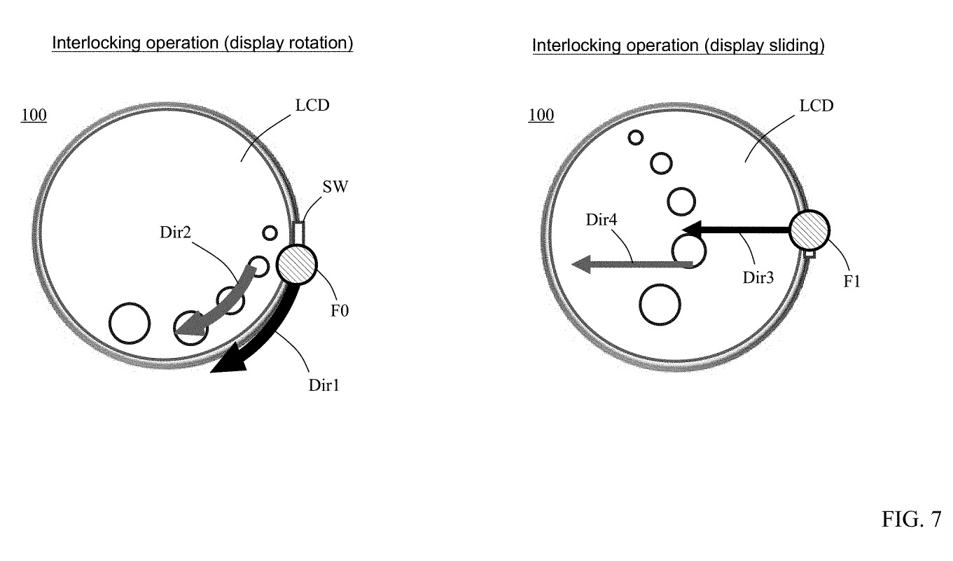

FIG. 7 is a view for explaining a display interlocking operation (display rotation, display sliding) in the touch-panel-equipped display device 100. More specifically, the left diagram in FIG. 7 is a schematic plan view of the touch-panel-equipped display device 100 when viewed from above the display surface, for explaining a case where an image displayed on the display panel LCD is rotated in an interlocking manner with a movement of a user's finger. The right diagram in FIG. 7 is a schematic plan view of the touch-panel-equipped display device 100 when viewed from above the display surface, for explaining a case where an image displayed on the display panel LCD is slid in an interlocking manner with a movement of a user's finger.

It should be noted that the processing operation from when a user touches the SW1 with a finger until when the touch panel TP is activated is identical to that described above.

### <<Interlocking Operation (Display Rotation)>>

First of all, the following description describes a case where an interlocking operation of display rotation is performed in the touch-panel-equipped display device 100, while referring to the left diagram in FIG. 7.

As illustrated in the left diagram in FIG. 7, a touch by a user with respect to the switch SW activates the touch panel TP. Then, the user performs an operation of moving the finger touching the switch SW in a direction indicated by an arrow Dir1 in the left diagram in FIG. 7, in such a manner that the finger travels along the peripheral part of the display panel LCD (the frame part of the touch-panel-equipped display device 100).

In the touch-panel-equipped display device 100, the touch panel TP is arranged so as to detect an electric field change (capacitive change) in a peripheral part of the display panel LCD (the frame part of the touch-panel-equipped display device 100) as well, which makes it possible to detect such an electric field change (capacitive change) as described above, on the touch panel caused by a movement of the finger. In the touch-panel-equipped display device 100, therefore, in a case where a user moves a finger touching the switch SW in a direction indicated by the arrow Dir1 in the left diagram in FIG. 7, in such a manner that the finger travels along the peripheral part of the display panel LCD (the frame part of the touch-panel-equipped display device 100), the trajectory of the finger can be appropriately detected. More specifically, the position information (position coordinates) of the user's finger can be continuously detected by the touch panel controller 2. Besides, the touch panel controller 2 continuously outputs the detected position information of the finger to the display panel controller 3 and the overall controller 4.

The overall controller 4 generates a control signal that instructs an image displayed on the display panel LCD to rotate in an interlocking manner with the position information of the user's finger detected by the touch panel controller 2, and outputs the generated control signal to the display panel controller 3.

Based on the control signal output from the overall controller 4, the display panel controller 3 generates a display panel driving signal for updating the image displayed on the display panel LCD (updating the image so that the image rotates in a direction indicated by an arrow Dir2 illustrated in FIG. 7 in an interlocking manner with the movement Dir1 of the user's finger). The display panel controller 3 outputs the generated display panel driving signal to the display panel LCD, so as to update the image displayed on the display panel LCD.

In the touch-panel-equipped display device 100, with this processing operation, when a user's finger touches the switch SW1 and moves in a direction Dir1 along the peripheral part of the display panel LCD, the touch panel TP can be activated in an interlocking manner with the movement of the finger, and an image displayed on the display panel LCD can be rotated.

### <<Interlocking Operation (Display Sliding)>>

Next, the following description describes a case where an interlocking operation of display sliding is performed in the touch-panel-equipped display device 100, while referring to the right diagram in FIG. 7.

As illustrated in the right diagram in FIG. 7, when a user touches the switch SW, the touch panel TP is activated. Then, the user performs an operation of moving the finger touching the switch SW in the direction indicated by an arrow Dir3 illustrated in the right diagram in FIG. 7.

In the touch-panel-equipped display device 100, since the touch panel TP is activated when the user's finger touches the switch SW, the movement of the user's finger in the direction indicated by the arrow Dir3 can be detected by the touch panel TP.

In other words, in the touch-panel-equipped display device 100, in a case where the user moves the finger that touches the switch SW in the direction indicated by the arrow Dir3 in the right diagram in FIG. 7, the trajectory of the finger can be appropriately detected. More specifically, the position information (position coordinates) of the user's finger can be continuously detected by the touch panel controller 2. Besides, the touch panel controller 2 continuously outputs the detect position information of the finger to the display panel controller 3 and the overall controller 4.

The overall controller 4 generates a control signal that instructs an image displayed on the display panel LCD to shift (to move in a direction Dir4) in an interlocking manner with the position information of the user's finger detected by the touch panel controller 2, and outputs the generated control signal to the display panel controller 3.

Based on the control signal output from the overall controller 4, the display panel controller 3 generates a display panel driving signal for updating the image displayed on the display panel LCD (updating the image so that the image shifts in the direction indicated by an arrow Dir4 in FIG. 7 and is displayed). The display panel controller 3 outputs the generated display panel driving signal to the display panel LCD, so as to update the image displayed on the display panel LCD.

In the touch-panel-equipped display device 100, with this processing operation, when a user's finger touches the switch SW1 and moves in a direction Dir3 toward the inner side of the display panel LCD, the touch panel TP can be activated in an interlocking manner with the movement of the finger, and an image displayed on the display panel LCD can be shifted (shifted in the direction indicated by the arrow Dir4).

### (1.2.2: Display Interlocking Operation (Display Scale-Down, Display Scale-Up))

Next, the following description describes a case where a display interlocking operation (display scale-down, display scale-up) is performed in the touch-panel-equipped display device 100.

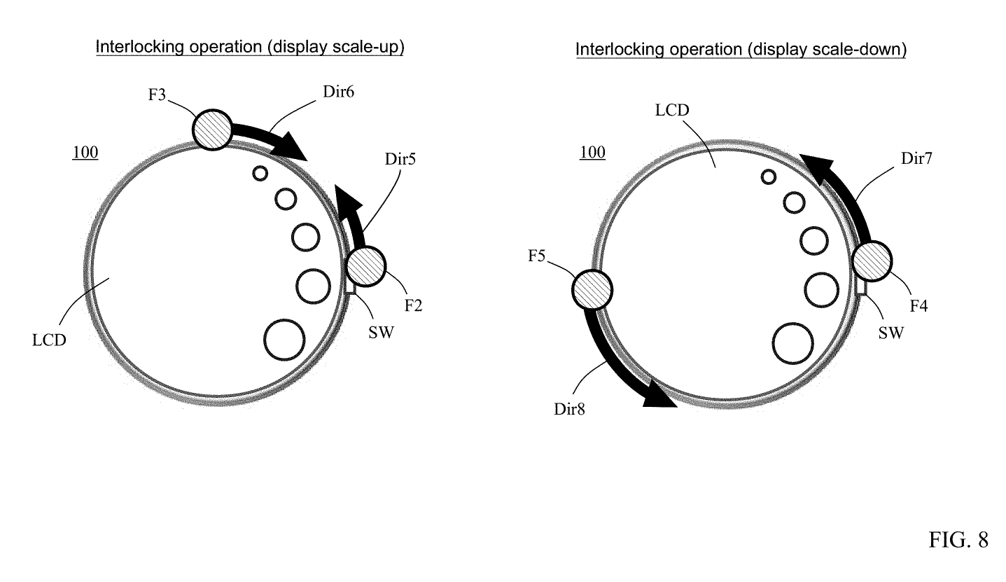

FIG. 8 is a view for explaining a display interlocking operation (display scale-down, display scale-up) in the touch-panel-equipped display device 100. More specifically, the left diagram in FIG. 8 is a schematic plan view of the touch-panel-equipped display device 100 when viewed from above the display surface, for explaining a case where an image displayed on the display panel LCD is displayed in a scaled-down state in an interlocking manner with the movement of a user's finger. The right diagram in FIG. 8 is a schematic plan view of the touch-panel-equipped display device 100 when viewed from above the display surface, for explaining a case where an image displayed on the display panel LCD is displayed in a scaled-up state in an interlocking manner with the movement of a user's finger.

It should be noted that the processing operation from when a user touches the SW1 with a finger until when the touch panel TP is activated is identical to that described above.

### <<Interlocking Operation (Display Scale-Down)>>

First of all, the following description describes a case where an interlocking operation for display scale-down is performed in the touch-panel-equipped display device 100, while referring to the left diagram in FIG. 8.

As illustrated in the left diagram in FIG. 8, while touching the switch SW with one finger, a user touches, with another finger, one point on a peripheral part of the display panel LCD (a frame part of the touch-panel-equipped display device 100). In the left diagram in FIG. 8, the finger touching the switch SW is denoted by “F2”, and the finger touching one point on the peripheral part of the display panel LCD (the frame part of the touch-panel-equipped display device 100) is denoted by “F3”.

In the touch-panel-equipped display device 100, since the finger F2 is touching the switch SW, the touch panel TP is activated. Then, the user moves the finger F2 in the direction indicated by an arrow Dir5 illustrated in FIG. 8, in such a manner that the finger travels along the peripheral part of the display panel LCD (the frame part of the touch-panel-equipped display device 100), and at the same time, moves the finger F3 in the direction indicated by an arrow Dir6 illustrated in FIG. 8, in such a manner that the finger travels along the peripheral part of the display panel LCD (the frame part of the touch-panel-equipped display device 100). In other words, the user moves the finger F2 and the finger F3 so that the position of the finger F2 and the position of the finger F3 approach to each other (performs a pinch-in operation).

In the touch-panel-equipped display device 100, since the touch panel TP is arranged in such a manner that an electric field change (capacitive change) can be detected even in the peripheral part of the display panel LCD (the frame part of the touch-panel-equipped display device 100) as well, an electric field change (capacitive change) in the touch panel caused by a movement of a finger (pinch-in operation) as described above can be detected. In the touch-panel-equipped display device 100, therefore, in a case where the user moves the finger F2 touching the switch SW in the direction indicated by the arrow Dir5 illustrated in the left diagram in FIG. 8 so that the finger F2 travels along the peripheral part of the display panel LCD (the frame part of the touch-panel-equipped display device 100), the trajectory of the finger F2 can be detected appropriately. Further, in the touch-panel-equipped display device 100, in a case where the user moves the finger F3 in the direction indicated by the arrow Dir6 illustrated in the left diagram in FIG. 8 so that the finger F3 travels along the peripheral part of the display panel LCD (the frame part of the touch-panel-equipped display device 100), the trajectory of the finger F3 can be detected appropriately.

More specifically, it is possible to continuously detect the position information (position coordinates) of the user's fingers F2 and F3, with use of the touch panel controller 2. The touch panel controller 2, then, continuously outputs the detected position information of the finger F2 and the finger F3 to the display panel controller 3 and the overall controller 4.

The overall controller 4 generates a control signal for instructing that the image displayed on the display panel LCD is displayed in a scaled-down state in an interlocking manner with the position information of the user's fingers F2 and F3 detected by the touch panel controller 2, and outputs the generated control signal to the display panel controller 3.

The display panel controller 3 generates a display panel driving signal for updating the image displayed on the display panel LCD (for displaying the image in a scaled-down state), based on the control signal output from the overall controller 4. The display panel controller 3 outputs the generated display panel driving signal to the display panel LCD, and updates the image displayed on the display panel LCD (displays the image in a scaled-down state).

In the touch-panel-equipped display device 100, with this processing operation, the touch panel TP can be activated, and the image displayed on the display panel LCD can be displayed in a scaled-down state, in an interlocking manner with the movement of the finger F2 touching the switch SW1 and the movement of the finger F3 touching the peripheral part of the display panel LCD. The image scaling-down rate may be determined according to the speeds of the fingers F2 and F3.

### <<Interlocking Operation (Display Scale-Up)>>

Next, the following description describes a case where an interlocking operation for display scale-up is performed in the touch-panel-equipped display device 100, while referring to the right diagram in FIG. 8.

As illustrated in the right diagram in FIG. 8, while touching the switch SW with one finger, a user touches, with another finger, one point on a peripheral part of the display panel LCD (the frame part of the touch-panel-equipped display device 100). In the right diagram in FIG. 8, the finger touching the switch SW is denoted by “F4”, and the finger touching one point on the peripheral part of the display panel LCD (the frame part of the touch-panel-equipped display device 100) is denoted by “F5”.

In the touch-panel-equipped display device 100, since the finger F4 is touching the switch SW, touch panel TP is activated. Then, the user moves the finger F4 in the direction indicated by an arrow Dir7 illustrated in FIG. 8, in such a manner that the finger travels along the peripheral part of the display panel LCD (the frame part of the touch-panel-equipped display device 100), and at the same time, moves the finger F5 in the direction indicated by an arrow Dir8 illustrated in FIG. 8, in such a manner that the finger travels along the peripheral part of the display panel LCD (the frame part of the touch-panel-equipped display device 100). In other words, the user moves the finger F4 and the finger F5 so that the position of the finger F4 and the position of the finger F5 move in identical rotation directions (performs a pinch-out operation).

In the touch-panel-equipped display device 100, since the touch panel TP is arranged in such a manner that an electric field change (capacitive change) can be detected even in the peripheral part of the display panel LCD (the frame part of the touch-panel-equipped display device 100), an electric field change (capacitive change) on the touch panel caused by a movement of the finger (pinch-out operation) as described above can be detected. In the touch-panel-equipped display device 100, therefore, in a case where the user moves the finger F4 touching the switch SW in the direction indicated by the arrow Dir7 illustrated in the right diagram in FIG. 8 so that the finger F4 travels along the peripheral part of the display panel LCD (the frame part of the touch-panel-equipped display device 100), the trajectory of the finger F4 can be detected appropriately. Further, in the touch-panel-equipped display device 100, in a case where the user moves the finger F5 in the direction indicated by the arrow Dir8 illustrated in the right diagram in FIG. 8 so that the finger F5 travels along the peripheral part of the display panel LCD (the frame part of the touch-panel-equipped display device 100), the trajectory of the finger F5 can be detected appropriately.

More specifically, it is possible to continuously detect the position information (position coordinates) of the user's fingers F4 and F5, with use of the touch panel controller 2. The touch panel controller 2, then, continuously outputs the detected position information of the fingers F4 and F5 to the display panel controller 3 and the overall controller 4.

The overall controller 4 generates a control signal for instructing that the image displayed on the display panel LCD is displayed in a scaled-up state in an interlocking manner with the position information of the user's fingers F4 and F5 detected by the touch panel controller 2, and outputs the generated control signal to the display panel controller 3.

The display panel controller 3 generates a display panel driving signal for updating the image displayed on the display panel LCD (for displaying the image in a scaled-up state), based on the control signal output from the overall controller 4. The display panel controller 3 outputs the generated display panel driving signal to the display panel LCD, and updates the image displayed on the display panel LCD (displays the image in a scaled-up state).

In the touch-panel-equipped display device 100, with this processing operation, the touch panel TP can be activated, and an image displayed on the display panel LCD can be displayed in a scaled-up state, in an interlocking manner with the movement of the finger F4 touching the switch SW1 and the movement of the finger F5 touching the peripheral part of the display panel LCD. The image scaling-up rate may be determined according to the speeds of the fingers F4 and F5.

### Modification Example 1

Next, the following description describes Modification Example 1 of Embodiment 1.

The following description describes parts characteristic of the present modification example, and regarding the parts identical to those in the above-described embodiment, detailed descriptions are omitted.

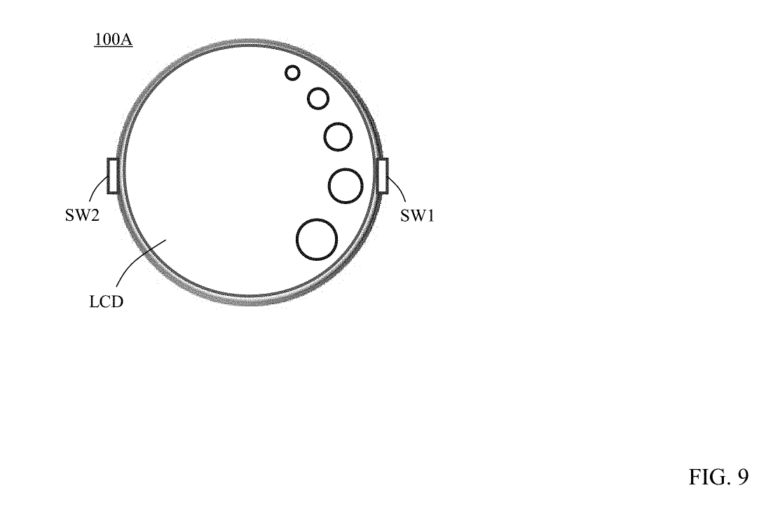

FIG. 9 is a schematic plan view of a touch-panel-equipped display device 100A of Modification Example 1, when viewed from above a display surface.

In the touch-panel-equipped display device 100 according to Embodiment 1, one switch SW is provided, but in the touch-panel-equipped display device 100A according to Modification Example 1, a plurality of switches SW are provided, as illustrated in FIG. 9 (in FIG. 9, two switches are provided).

The switches SW1, SW2 in the touch-panel-equipped display device 100A are connected to the overall controller 4, and the switches SW1, SW2 can be turned ON when a user touches the switches.

For example, in the touch-panel-equipped display device 100A, when a user touches either the switch SW1 or the switch SW2 with a finger, the touch panel TP is activated, as in Embodiment 1. Then, in the touch-panel-equipped display device 100A, for example, the user touching both of the switches SW1, SW2 with fingers can cause the touch panel TP to be activated, and further can cause a predetermined application to operate.

In this way, in the touch-panel-equipped display device 100A, when a user touches both of the switches SW1, SW2 with fingers, the activation of the touch panel TP and the processing operation of the predetermined application are executed successively. This makes it possible to prevent a user from unintentionally touching either the switches SW1, SW2 thereby causing a predetermined application to be executed against the intention of the user.

The touch-panel-equipped display device 100A according to the present modification example is described with reference to a case where two switches are provided, but the number of the switches is not limited to this. The number of the switches may be three or more.

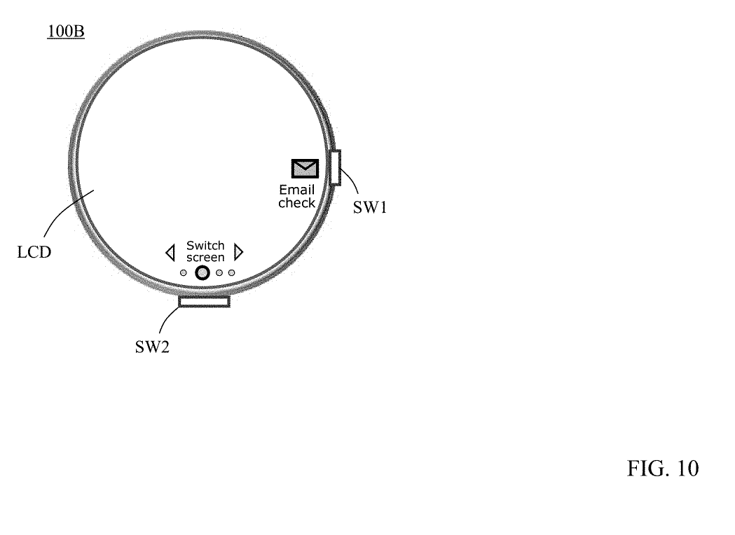

Further, the following description describes an application example of the touch-panel-equipped display device including two switches, while referring to FIG. 10.

FIG. 10 is a schematic plan view of a touch-panel-equipped display device 100B including a switch SW1 and a switch SW2, when viewed from above the display surface thereof.

As illustrated in FIG. 10, in the touch-panel-equipped display device 100B, (1) an icon assigned to an application (in the case of FIG. 10, email check) that is executed when the switch SW1 is touched is displayed in the vicinities of the switch SW1 in the display panel LCD, and (2) an icon assigned to an application (in the case of FIG. 10, “Switch screen”) that is executed when the switch SW2 is touched is displayed in the vicinities of the switch SW2 in the display panel LCD.

In the touch-panel-equipped display device 100B, when the switch SW1 is touched by a user, the touch panel TP is activated, and further, an application (in the case of FIG. 10, email check) assigned to the switch SW1 is executed.

Further, in the touch-panel-equipped display device 100B, when the switch SW2 is touched by a user, the touch panel TP is activated, and further, when the user slides the finger touching the switch SW2 to the right and the left, the application assigned to the switch SW2 (in the case of FIG. 10, “Switch screen”) is executed. In other words, according to the sliding direction in which the user's finger is slid, the screen is switched.

In this way, in the touch-panel-equipped display device 100B, the predetermined application operations are assigned to the two switches SW1 and SW2, whereby the touch panel TP can be activated, and the predetermined application operations can be executed with excellent operability.

### Modification Example 2

Next, the following description describes Modification Example 2 of Embodiment 1.

The following description describes parts characteristic of the present modification example, and regarding the parts identical to those in the above-described embodiment, detailed descriptions are omitted.

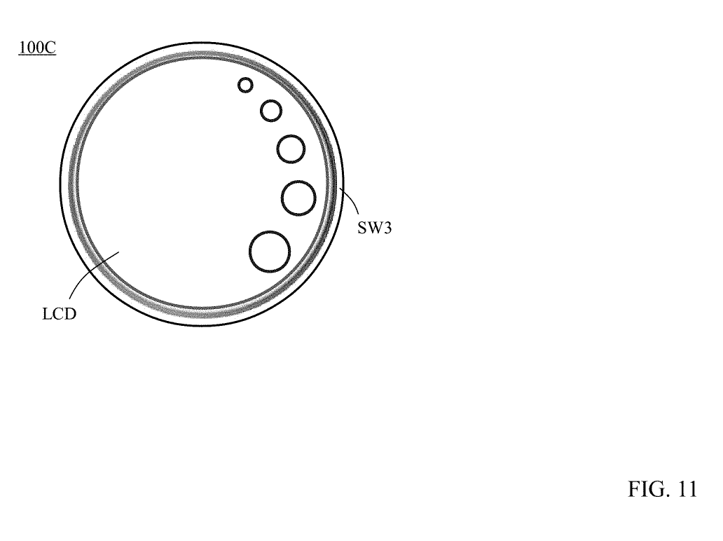

FIG. 11 is a is a schematic plan view illustrating a touch-panel-equipped display device 100C according to Modification Example 2, viewed from above a display surface.

In the touch-panel-equipped display device 100 according to Embodiment 1, the switch SW is formed only in a part of the peripheral part of the display panel LCD of the touch-panel-equipped display device 100 when viewed in a plan view, but in the touch-panel-equipped display device 100C according to Modification Example 2, the switch SW3 is formed in an entire area surrounding the peripheral part of the display panel LCD of the touch-panel-equipped display device 100C when viewed in a plan view, as illustrated in FIG. 11. In other words, in the touch-panel-equipped display device 100C, the switch SW3 is formed on an entire side surface of the case B1.

The switch SW3 of the touch-panel-equipped display device 100C, as is the case with Embodiment 1, is connected to the overall controller 4, and when a user touches the switch SW3, the switch can be turned ON.

In the touch-panel-equipped display device 100C, since the switch SW3 is formed on the entire side surface of the case B1, the range that can be touched by a user with a finger in order to activate the touch panel TP is expanded, whereby the convenience is improved.

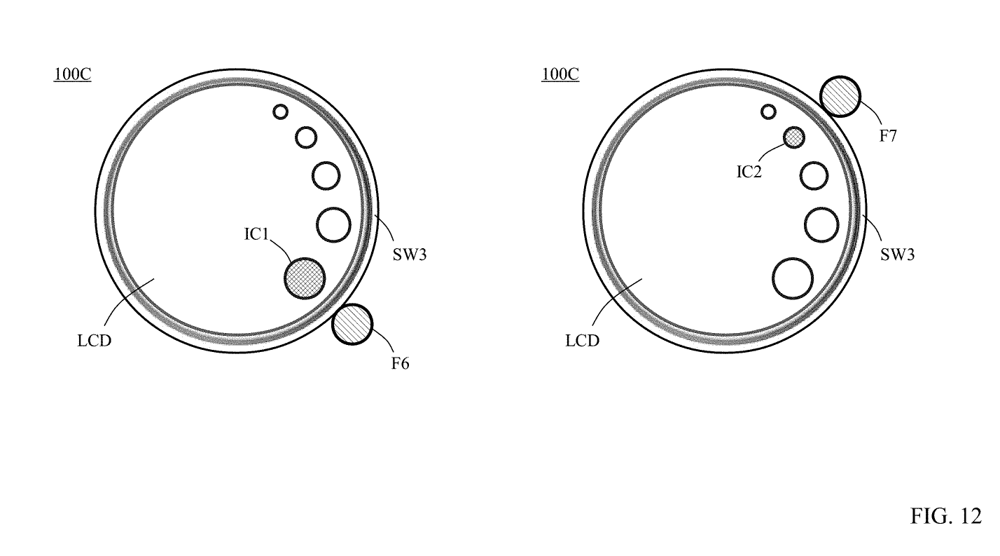

As illustrated in FIG. 12, in the touch-panel-equipped display device 100C, in order that the touch position on the switch SW3 is clearly indicated, a display in which a touch position is clearly indicated may be included in the display on the display panel LCD. For example, in the case of the left diagram in FIG. 12, when a user touches the switch SW3 at the finger position F6, the touch panel TP is activated, and an icon 101 close to the touch position may be displayed with, for example, a predetermined color in the touch-panel-equipped display device 100C, so that a display clearly indicating the touch position is may be shown. Further, in the case of the right diagram in FIG. 12, when a user touches the switch SW3 at the finger position F7, the touch panel TP is activated, and an icon IC2 close to the touch position may be displayed with, for example, a predetermined color in the touch-panel-equipped display device 100C, so that a display clearly indicating the touch position is may be shown.

With this configuration, in the touch-panel-equipped display device 100C, the touch position can be clearly indicated.

The foregoing description describes a case where a touch position is clearly indicated by changing an image in the vicinities of the touch position in a preliminarily displayed image, but the configuration is not limited to this. For example, the configuration may be as follows: in the touch-panel-equipped display device 100C, after the touch position on the switch SW3 is detected, an image clearly indicating the touch position (for example, an icon indicating the touch position) may be displayed in the vicinities of the touch position, on the display panel LCD.

### Other Embodiments

Part or all of the above-described embodiment and modification examples may be combined so as to realize a touch-panel-equipped display device.

Further, as is the case with Modification Example 2 of Embodiment 1 described above, in the touch-panel-equipped display device 100 according to Embodiment 1, and the touch-panel-equipped display device 100A according to Modification Example 1 of Embodiment 1 as well, a display (for example, an icon display) clearly indicating the position at which the switch SW, SW1, SW2 is touched may be executed on the display panel LCD. In this case, the touch position may be clearly indicated by (1) changing an image (for example, an icon) preliminarily displayed on the display panel LCD (for example, by changing the color thereof), or (2) after the touch position is detected, causing an image (for example, an icon) clearly indicating the touch position to appear in the vicinities of the touch position.

Further, the embodiments (including the modification examples) are described above with reference to a case where the number of the gate lines, the number of the sense lines, the number of the gate electrode areas, and the number of the sense electrode areas are “8” each, but the configuration is not limited to this. The number of the gate lines, the number of the sense lines, the number of the gate electrode areas, and the number of the sense electrode areas may be other numbers, respectively.

Further, the embodiments (including the modification examples) are described above with reference to a case where the touch-panel-equipped display device is in a circular shape when viewed in a plan view, but the configuration is not limited to this. The shape may be another shape (for example, a rectangular shape).

Further, the embodiments (including the modification examples) are described with reference to a case of a touch-panel-equipped display device in which the drive lines are arranged within the touch panel TP area when viewed in a plan view, but the configuration is not limited to this. For example, the touch-panel-equipped display device may have such a configuration that the sense lines are arranged within the touch panel TP area when viewed in a plan view, or such a configuration that both of the sense lines and the gate lines are arranged within the touch panel TP area when viewed in a plan view.

Further, the electrodes (the drive electrodes, the sense electrodes) of the touch panel TP are not limited to those formed with a mesh pattern of thin metal wires. The electrodes (the drive electrodes, the sense electrodes) of the touch panel TP may be, for example, transparent electrodes made of indium tin oxide (ITO).

Further, a part of an entirety of the touch-panel-equipped display device of the above-described embodiments may be realized as an integrated circuit (for example, an LSI, a system LSI, or the like).

A part or an entirety of a processing operation of each function block of the above-described embodiments may be realized with programs. A part or an entirety of a processing operation of each function block of the above-described embodiments may be executed by a central processing unit (CPU) in a computer. Further, the programs for executing the respective processing operations may be stored in a storage device such as a hard disk or a ROM, and the central processing unit (CPU) may read the programs from a ROM or a RAM and execute the same.

Further, each processing operation in the above-described embodiments may be realized with hardware, or may be realized with software (including a case of being realized together with an operating system (OS)), middleware, or a predetermined library). Further alternatively, each processing operation may be realized with software and hardware in combination.

Still further, the order of execution of operations in the processing method in the above-described embodiments is not limited to that in the above-described embodiments. The order can be changed without deviating from the scope of the invention.

A computer program that causes a computer to execute the above-described method, and a computer-readable recording medium in which the program is recorded, are encompassed in the scope of the present invention. Here, examples of the computer-readable recording medium include a flexible disk, a hard disk, a CD-ROM, an MO, a DVD, a large-capacity DVD, a next-generation DVD, and a semiconductor memory.

The above-described computer program is not limited to a program recorded in the above-described recording medium, but may be a program that is transmitted through a network or the like that is typically, for example, an electric communication channel, a wireless or wired communication channel, or the Internet.

Still further, in part of the descriptions of the above-described embodiments, only principal members essential for the above-described embodiments, among the constituent members, are described in a simplified manner. The configurations of the above-described embodiments can include arbitrary constituent members that are not clearly mentioned in the descriptions of the embodiments. Further, in the descriptions and the drawings of the above-described embodiments, some of the respective sizes of the members do not faithfully represent the real sizes, the real dimension ratios, and the like.

The specific configuration of the present invention is not limited to the configurations of the above-described embodiments, but can be variously changed and modified without deviating from the scope of the invention.

### [Supplementary Note]

The present invention can be also described as follows.

The first invention is a touch panel device that includes a capacitive type touch panel, a first switch, and a controller.

The first switch is a switch for activating the touch panel, the switch being provided in an area within such a distance from the touch panel that the switch can be capacitively coupled with the touch panel.

The controller controls the touch panel and the first switch.

In this touch panel device, since the distance between the touch panel and the first switch is so small that the touch panel and the first switch can be capacitively coupled, a touch with respect to the first switch can activate the touch panel, and at the same time, makes it possible to detect the position of the touch with respect to the first switch on the touch panel.

In this touch panel device, therefore, the operability of the touch panel operation can be improved, and the electric power consumption for a touch panel operation can be reduced.

“Such a distance from the touch panel that the switch and the touch panel can be capacitively coupled” is, for example, a distance of 3 mm or smaller, and preferably, a distance of 2 mm or smaller.

The second invention is the first invention in which, when detecting a state of contact with the first switch, the controller (1) activates the touch panel, and (2) detects the touch point with respect to the first switch on the touch panel.

In this touch panel device, since the distance between the touch panel and the first switch is so small that the touch panel and the first switch can be capacitively coupled, the position of the touch with respect to the first switch can be detected with use of the touch panel. In this touch panel device, therefore, when a user performs an operation for activating the touch panel with use of the first switch (performs an operation of causing the touch panel to shift to an active state), approximately at the same time as the operation, the position information of the user's finger touching the first switch can be detected.

With this configuration, in this touch panel device, unlike a conventional touch panel device, it is not necessary to perform the following two steps (two-stage operation): (1) a step of causing the touch panel TP to shift to an active state, by using the switch; and (2) a step of touching the touch panel so as to perform an operation with use of the touch panel. In other words, in the case of the touch panel device, without such a complicated operation as that of a conventional touch panel device, upon the activation of the touch panel, substantially simultaneously (with substantially no delay), the position of a user's finger touching the first switch SW can be detected with use of the touch panel. With this configuration, the touch panel device has operability that is significantly improved as compared with conventional cases.

Further, in the case of the touch panel device, when the touch panel is operated, the touch panel is activated by the first switch. The electric power, therefore, is consumed in the touch panel only when the touch panel is operated. In this touch panel device, therefore, it is possible to reduce the electric power consumption for the touch panel operation, while improving the operability of the touch panel operation.

The third invention is the first or second invention that further includes a display panel for displaying an image.

The controller controls the display panel.

The touch panel is formed in an area that includes an area occupied by the display panel and that is greater than the display panel, when viewed in a plan view.

This makes it possible to realize a touch panel device that includes a touch panel that is provided in an area greater than the display panel when viewed in a plan view. In this touch panel device, since the area for the touch panel exists in, for example, an area where the display panel area is not present and that is a frame region when viewed in a plan view, the position of the touch can be appropriately detected even in a case, for example, the touch is with respect to the frame region of the touch panel device.

The fourth invention is any one of the first to third inventions in which at least either the drive lines or the sense lines of the touch panel are arranged within a touch panel surface of the touch panel when viewed in a plan view.

In this touch panel device, at least either the drive lines or the sense lines of the touch panel are arranged on a touch panel surface of the touch panel when viewed in a plan view. As compared with a conventional touch panel device, therefore, an area (frame region) necessary for arranging the drive lines and/or the sense lines can be formed smaller. This makes it possible to realize a narrow frame-type touch panel device.

The fifth invention is any one of the first to fourth inventions that further includes a second switch for activating the touch panel, the second switch being provided in an area within such a distance from the touch panel that the second switch can be capacitively coupled with the touch panel.

The controller, when detecting a state of contact with respect to the first switch or the second switch, (1) activates the touch panel, and (2) detects, on the touch panel, a touch point with respect to the first switch or the second switch.

In this touch panel device, the touch panel can be activated with use of two switches, whereby the operability can be further improved.

### INDUSTRIAL APPLICABILITY

Since the present invention makes it possible to realize a touch panel device having improved operability, with reduced electric power consumption in a touch panel thereof. The present invention, therefore, is useful in the touch panel device-related industrial fields, and can be implemented in these fields.

### DESCRIPTION OF REFERENCE NUMERALS

100, 100A, 100B, 100C touch panel device (touch-panel-equipped display device)
TP touch panel
SW switch (first switch)
LCD display panel
B1 case

1: A touch panel device comprising:
a capacitive type touch panel;
a first switch for activating the touch panel, the first switch being provided in an area within such a distance from the touch panel that the first switch can be capacitively coupled with the touch panel; and
a controller that controls the touch panel and the first switch.

2: The touch panel device according to claim 1,
wherein the controller, when detecting a state of contact with respect to the first switch,
(1) activates the touch panel, and
(2) detects, on the touch panel, a touch point with respect to the first switch.

3: The touch panel device according to claim 1, further comprising a display panel that displays an image,
wherein the controller controls the display panel, and
the touch panel is formed in an area that includes an area occupied by the display panel and that is greater than the display panel, when viewed in a plan view.

4: The touch panel device according to claim 1,
wherein at least either drive lines or sense lines of the touch panel are arranged within a touch panel surface of the touch panel when viewed in a plan view.

5: The touch panel device according to claim 1, further comprising a second switch for activating the touch panel, the second switch being provided in an area within such a distance from the touch panel that the second switch can be capacitively coupled with the touch panel,
wherein the controller, when detecting a state of contact with respect to the first switch or the second switch,
(1) activates the touch panel, and
(2) detects, on the touch panel, a touch point with respect to the first switch or the second switch.
